(19) United States
(12) Patent Application Publication
(10) Pub. No.: US 2003/0235109 A1
(43) Pub. Date: Dec. 25, 2003

(54) Mixer apparatus

(76) Inventor: William S. Knight, Brodhead, WI (US)

Correspondence Address: DAVID J. ARCHER, 7037 POMEROY RD., ROCKTON, IL, 61072, US

(21) Appl. No.: 10/446,174

(22) Filed: May 27, 2003

Related U.S. Application Data
(63) Continuation-in-part of application No. 09/811,309, filed on Mar. 16, 2001.
Application No. 09/811,309 is a continuation-in-part of application No. 09/808,550, filed on Mar. 14, 2001.
Application No. 09/808,550 is a continuation-in-part of application No. 09/590,347, filed on Jun. 8, 2000, now Pat. No. 6,467,945.
Application No. 09/590,347 is a continuation-in-part of application No. 09/562,167, filed on May 2, 2000, now Pat. No. 6,409,376.

(51) Int. Cl. B01F 7/24

(52) U.S. Cl. 366/314; 366/318; 366/603

(57) ABSTRACT

A mixer apparatus is disclosed for mixing livestock feed. The apparatus includes a container for the reception therein of the feed. The container has a housing and a wall extending away from the housing, the wall defining an opening disposed remote from the housing for the reception therethrough of the feed. The arrangement is such that the housing and the wall define therebetween an enclosure for the feed received through the opening. An auger is disposed within the enclosure, the auger having an axis of rotation extending through the housing. Additionally, a substantially horizontally disposed drive pinion is provided which intermeshes with a final driven wheel which is driven by the drive pinion and disposed substantially horizontally within the housing. The final driven wheel is rotatable about the axis of rotation, the final driven wheel being drivingly connected to the auger so that when the final driven wheel is rotated within the housing, the auger is rotated therewith within the enclosure for mixing the feed. Also, the final driven wheel has a diameter of at least three foot.

### CROSS REFERENCE TO RELATED APPLICATIONS

This application is a continuation-in-part of co-pending application U.S. Ser. No. 09/811,309 filed Mar. 15, 2001 which is a continuation-in-part of co-pending application U.S. Ser. No. 09/808,550 filed Mar. 14, 2001 which is a continuation-in-part of co-pending application U.S. Ser. No. 09/590,347 filed Jun. 8, 2000 which is a continuation-in-part of co-pending application U.S. Ser. No. 09/562,167 filed May 2, 2000. All the subject matter of the aforementioned applications are incorporated herein by reference.

### BACKGROUND OF THE INVENTION

1. Field of the Invention

The present invention relates to a mixer apparatus for mixing livestock feed. More specifically, the present invention relates to a vertical auger mixer having at least one auger.

2. Information Disclosure Statement

Cattle farming requires the mixing of various livestock feeds for subsequent distribution. Additionally, mixers can be used for mixing other materials such as composts and the like. Sometimes such mixing of feeds includes depositing at least one bale of hay into a mixer container together with other additives. The materials within the container are mixed by means of at least one auger which rotates within the container so that an intimate mixing of the contents of the container is obtained. Although many mixers employ a pair of horizontal interacting augers extending longitudinally along the container, several mixers have been proposed in which the auger or augers are disposed vertically.

In the prior art mixers of the vertical auger type, such mixers sometimes include a pair of augers in which the rotational axes of the augers are disposed spaced and parallel relative to each other. Furthermore, each of such augers is driven by a separate drive which supplies rotary motion to each of the augers from below.

Also, some mixers have a single auger. However, the aforementioned twin auger mixers suffer from the following drawbacks. First, the provision of two 90 degree drives and associated planetary reduction gearboxes is extremely expensive and involves the manufacture of many parts. Second, access to such gearboxes requires removal of the gearboxes from underneath the mixer and then disassembly of such gearboxes. Third, the augers include continuous flighting which provides less agitation of the feed. Fourth, at the end of a mixing operation, an operator will usually find it necessary to rev up the power take off in an attempt to throw materials centrifugally away from the augers so that the augers are cleaned. Fifth, when weighing materials to be mixed, inaccurate measurements are made when the mixer is on uneven ground. Such inaccuracies are caused mainly because when a load cell is disposed at the hitch of a drawbar, the reading reflects a vector rather than a vertical weight when the mixer is tilted. Most of the aforementioned drawbacks are also applicable to single auger mixers and the cost of providing a planetary gearbox and other parts is considerable.

Also, the apparatus according to the present invention includes a final driven wheel which has a diameter of at least three foot and preferably a diameter of at least five foot.

The present invention provides a vertical auger mixer apparatus which overcomes all of the aforementioned problems associated with the prior art arrangements.

Therefore, it is a primary feature of the present invention to provide a mixer apparatus in which the final driven wheel has a diameter of at least three foot and preferably a diameter of at least five foot for simplifying and thus reducing the cost of the apparatus and for enabling frozen bales of feed to be processed.

Other features and advantages of the mixer apparatus according to the present invention will be readily apparent to those skilled in the art by a consideration of the detailed description contained herein of a preferred embodiment of the present invention.

### SUMMARY OF THE DISCLOSURE

The present invention relates to a mixer apparatus for mixing livestock feed. The apparatus includes a container for the reception therein of the feed. The container has a housing and a wall extending away from the housing, the wall defining an opening disposed remote from the housing for the reception therethrough of the feed. The arrangement is such that the housing and the wall define therebetween an enclosure for the feed received through the opening. An auger is disposed within the enclosure, the auger having an axis of rotation extending through the housing. Additionally, a substantially horizontally disposed drive pinion is provided which intermeshes with a final driven wheel which is driven by the drive pinion and disposed substantially horizontally within the housing. The final driven wheel is rotatable about the axis of rotation, the final driven wheel being drivingly connected to the auger so that when the final driven wheel is rotated within the housing, the auger is rotated therewith within the enclosure for mixing the feed. Also, the final driven wheel has a diameter of at least three foot.

In a more specific embodiment of the present invention, the final driven wheel has a diameter of at least four foot. More specifically, the final driven wheel has a diameter of at least five foot. Also, the final driven wheel is a bull gear having at least 50 gear teeth. More specifically, the final driven wheel has from 56-105 gear teeth and is flame hardened.

The final driven wheel has a thickness within a range from 1 to 2 inches and the pinion which intermeshes with the final driven wheel has between 10 and 12 gear teeth.

The pinion which intermeshes with the final driven wheel has a thickness within a range from 1.50 to 4.50 inches and has a thickness which is greater than a thickness of the final driven wheel.

In a preferred embodiment of the present invention, the pinion which intermeshes with the final driven wheel is fabricated from steel and then hardened.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a perspective view of a mixer apparatus according to the present invention having twin augers;

FIG. 1a is a perspective view of a mixer apparatus having a single auger;

FIG. 2 is a side elevational view of the mixer apparatus shown in FIG. 1a;

FIG. 3 is a top plan view of the mixer apparatus shown in FIG. 2;

FIG. 4 is a top plan view of an alternative embodiment of the present invention;

FIG. 5 is a side elevational view of another embodiment of the present invention;

FIG. 6 is an enlarged side elevational view of the auger shown in FIG. 2;

FIG. 7 is an enlarged view of the drive gear pinion and driven wheel shown in FIG. 1a;

FIG. 7a is a similar view to that shown in FIG. 7 but shows a preferred embodiment of the present invention;

FIG. 7b is a view taken on the line 7b-7b of FIG. 7a;

FIG. 8 is a top plan view similar to FIG. 7 of an alternative embodiment of the present invention;

FIG. 9 is a top plan view of a further embodiment of the present invention;

FIG. 10 is a diagrammatic representation viewed from the top of another embodiment of the present invention;

FIG. 11 is a top plan view of another embodiment of the present invention;

FIG. 12 is a sectional view taken on the line 12-12 of FIG. 11;

FIG. 13 is a view taken from beneath the mixer apparatus shown in FIG. 3; and

FIG. 14 is an enlarged perspective view of the hitch bar as shown in FIG. 1.

Similar reference characters refer to similar parts throughout the various embodiments of the present invention.

### DETAILED DESCRIPTION OF THE DRAWINGS

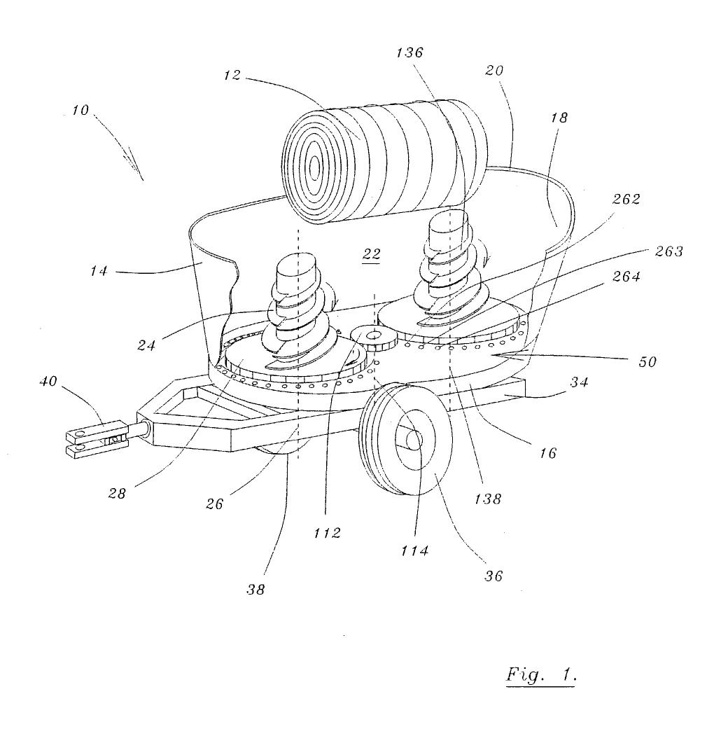

FIG. 1 is a perspective view of a mixer apparatus generally designated 10 for mixing livestock feed and the like 12. The apparatus 10 includes a container 14 for the reception therein of the feed 12. The container 14 includes a housing generally designated 16 and a wall 18 extending away from the housing 16. The wall 18 defines an opening 20 which is disposed remote from the housing 16 for the reception therethrough of the feed 12. The arrangement is such that the housing 16 and the wall 18 define therebetween an enclosure 22 for the feed 12 received through the opening 20. An auger 24 is disposed within the enclosure 22, the auger 24 having an axis of rotation 26 which extends through the housing 16. The mixer apparatus 10 further includes a further auger 136 which is disposed within the enclosure 22, the further auger 136 having a rotational axis 138 disposed approximately parallel and spaced from the axis of rotation 26 of the auger 24. The mixer 10 also has a drive wheel 112 which is common to the auger 24 and the further auger 136, the drive wheel 112 having a further axis of rotation 114 which is disposed spaced and approximately parallel relative to the axis of rotation 26 of the auger 24 and the rotational axis 138 of the further auger 136.

As shown in FIG. 1, the mixer apparatus 10 also includes a final driven wheel 28 disposed within the housing 16, the final driven wheel 28 being rotatable about the axis of rotation 26. The final driven wheel 28 is drivingly connected to the auger 24 so that when the final driven wheel 28 is rotated within the housing 16, the auger 24 is rotated therewith within the enclosure 22 for mixing the feed, the final driven wheel 28 being driven by the drive wheel 112.

As shown in FIG. 1, the container 14 further includes a frame 34 for supporting the housing 16 thereon. The container 14 also includes a plurality of wheels 36 and 38 which are rotatably secured to the frame 34 for permitting transportation of the mixer apparatus 10. Additionally, the container 14 includes a hitch bar 40 which is secured to the frame 34 for facilitating transportation of the mixer apparatus 10 by a tractor or the like (not shown).

FIG. 1a is a perspective view of another embodiment of the present invention in which the mixer has a single auger. It will be understood by those skilled in the art that the various features to be described relative to the single auger mixer are equally applicable to the twin auger mixer described with reference to FIG. 1. As shown in FIG. 1a, the housing 16′ includes a base 42 and a rim 44 having a first and a second end 46 and 48 respectively. The first end 46 of the rim 44 is secured to the base 42. A floor 50 is disposed between the auger 24′ and the final driven wheel 28′, the floor 50 being secured to the second end 48 of the rim 44 such that the base 42, the rim 44 and the floor 50 define therebetween an encasement 52 for the final driven wheel 28′. Furthermore, the floor 50 defines an access hole 54 for permitting removal and replacement therethrough of the final driven wheel 28′. The floor 50 includes a cover 56 which has been removed for clarity in FIG. 1. The cover 56 is for covering the access hole 54.

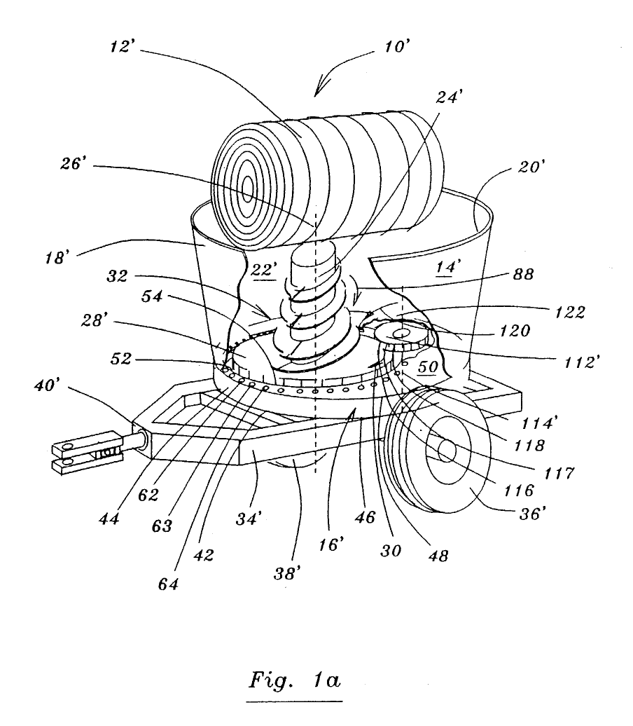

FIG. 2 is a side elevational view of the mixer apparatus shown in FIG. 1a. As shown in FIG. 2, the cover 56 defines an aperture 58 through which the axis of rotation 26′ extends so that driving of the auger 24′ by the final driven wheel 28′ is permitted. Moreover, the cover 56 includes a bearing 60 which extends through the aperture 58, the bearing 60 being disposed between the auger 24′ and the final driven wheel 28′ for bearingly supporting the auger 24′ and the final driven wheel 28′ for permitting rotation of the auger 24′ and the final driven wheel 28′ when the final driven wheel 28′ is being driven.

As also shown in FIGS. 1a and 2, the floor 50 defines an array of bores 62, 63 and 64 disposed around the access hole 54.

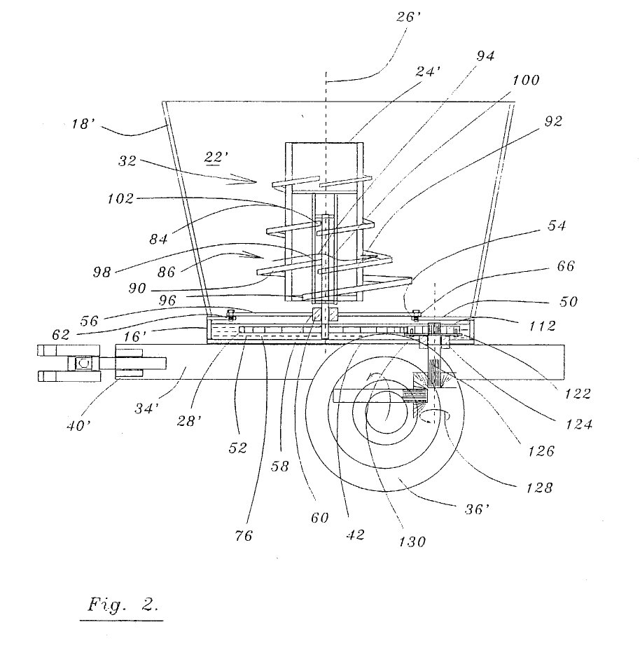

FIG. 3 is a top plan view of the apparatus 10′ shown in FIG. 2. As shown in FIG. 3, the cover 56 has a peripheral edge 66 which defines a plurality of holes 68, 69 and 70. A plurality of fasteners 72, 73 and 74 are arranged such that each fastener such as fastener 72 extends through a hole such as hole 68 of the plurality of holes 68-70 and an aligned bore such as bore 62 of the array of bores 62-64 shown in FIG. 1a for removably fastening the cover 56 to the floor 50. The encasement 52 is filled with lubricant 76 for lubricating the final driven wheel 28′ as shown in FIG. 2.

Also, as shown in FIGS. 1a-3, the wall 18′ extends angularly away from the housing 16′. Preferably, the wall 18′ defines a discharge outlet 78 shown in FIG. 3 for the discharge therethrough of the feed 12′. The discharge outlet 78 includes a door 79 and at least one rotary expeller 80 for moving the feed 12′ away from the enclosure 22′.

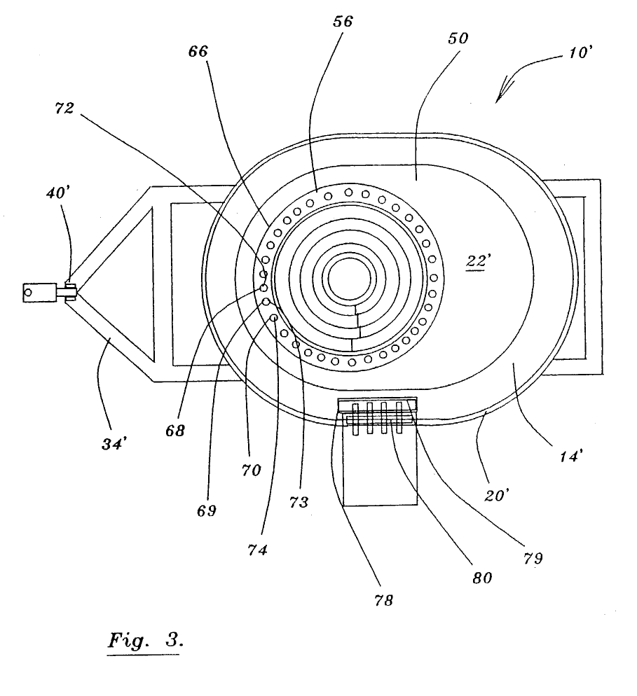

FIG. 4 is a top plan view of an alternative embodiment of the present invention. As shown in FIG. 4, a discharge outlet 78a includes a conveyor 82 for conveying the feed 12a away from the enclosure 22a and a door 79a which is movable relative to the discharge outlet 78a.

In another feature of the present invention as shown in FIG. 2, the auger 24′ includes a core 84 and flighting generally designated 86 is connected to the core 84 so that when the auger 24′ rotates as indicated by the arrow 88 as shown in FIG. 1a, feed 12′ disposed within the enclosure 22′ is mixed. The core 84 is of cylindrical configuration and the flighting 86 is disposed helically around the core 84. More specifically as shown in FIG. 2, the flighting 86 includes a first portion 90 and a second portion 92 which is staggered relative to the first portion 90 such that movement of the feed 12′ as indicated by the arrow 94 between the first and second portions 90 and 92 respectively is interrupted. The first portion 90 has a first and a second end 96 and 98 respectively and is of spiral configuration. The first end 96 is disposed adjacent to the housing 16′. The second portion 92 has a first and a second extremity 100 and 102 respectively, the first extremity 100 being disposed in an adjacent spaced relationship relative to the second end 98 of the first portion 90. The second portion 92 also is of spiral configuration. Those skilled in the art will appreciate that the core 84 could be of conical configuration or of square cross sectional configuration without departing from the spirit and concept of the present invention.

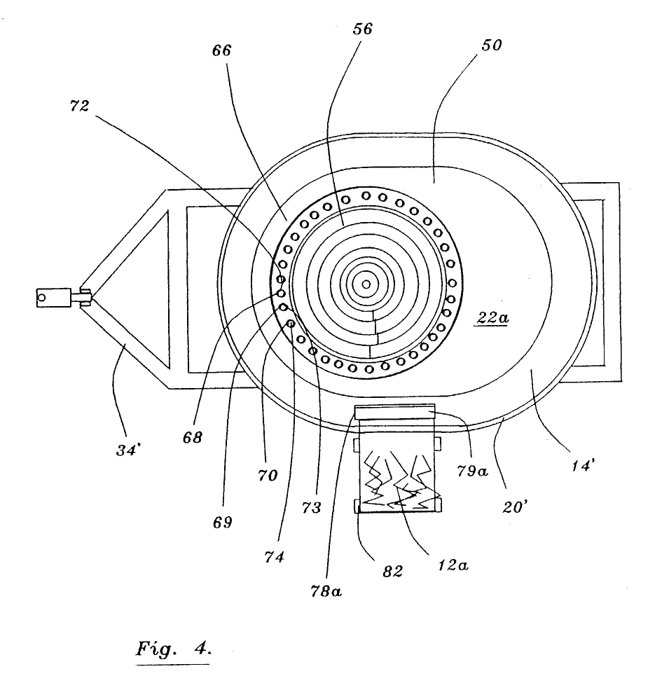

FIG. 5 is a side elevational view of another embodiment of the present invention. As shown in FIG. 5, an auger 24b includes a first portion 90b which is a paddle 91 and a second portion 92b is a further paddle 93. The further paddle 93 is disposed in staggered relationship with paddle 91 as shown in FIG. 5. Also, as shown in FIG. 5, both of the paddles 91 and 93 extend from a core 84b of the auger 24b.

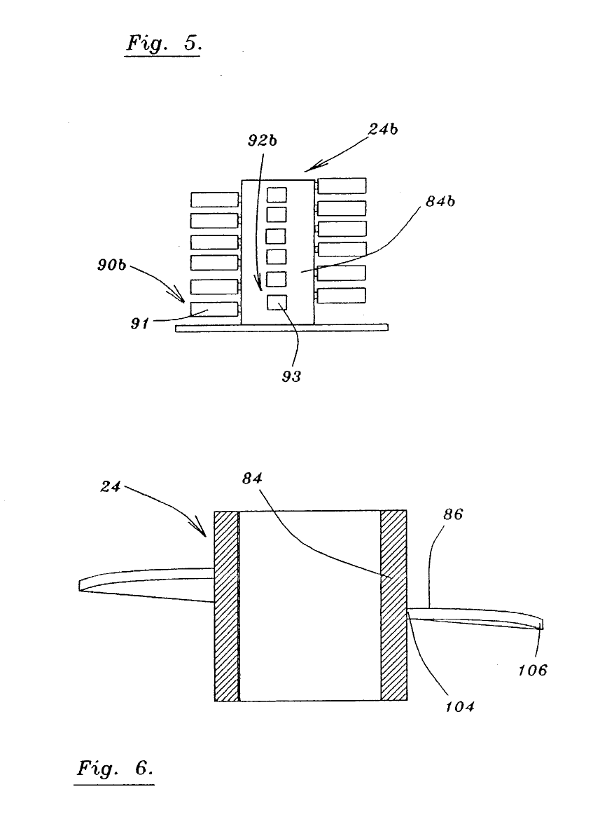

FIG. 6 is an enlarged side elevational view of the auger 24′ shown in FIG. 2. As shown in FIG. 6, the flighting 86 has an inner edge 104 and an outer edge 106, the inner edge 104 being connected to the core 84. The outer edge 106 is canted towards the housing 16′ such that discharging and cleaning of feed 12′ from the auger 24′ during an unloading operation is facilitated.

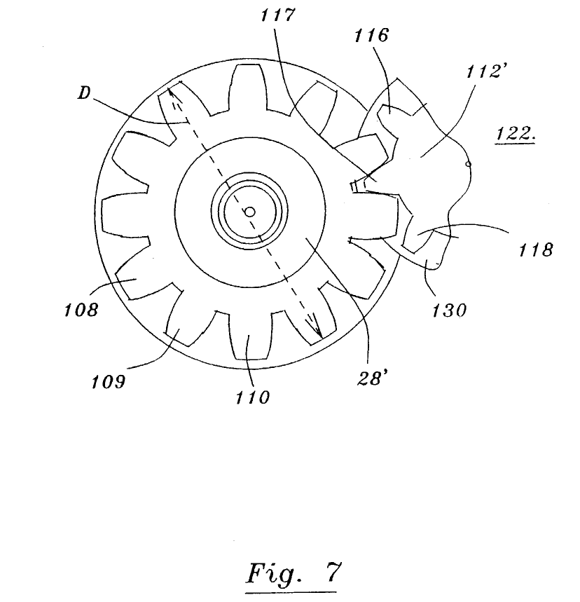

FIG. 7 is an enlarged top plan view of the final driven wheel 28′ shown in FIG. 1a. As shown in FIG. 7, the final driven wheel 28′ is a gear wheel. The gear wheel 28′ includes a plurality of straight teeth 108, 109 and 110. In a preferred embodiment of the present invention, the gear wheel 28′ has a diameter D of at least three foot.

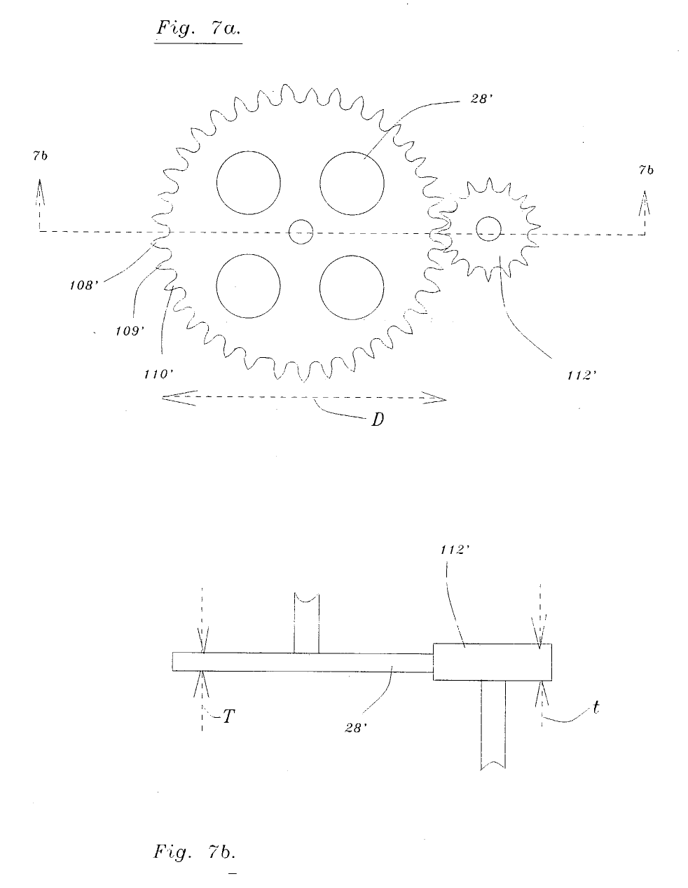

FIG. 8 is a top plan view similar to FIG. 7 of an alternative embodiment of the present invention. As shown in FIG. 8, the final driven wheel 28c is a driven sprocket wheel with driven sprocket teeth 108c, 109c and 110c. Also, as shown in FIG. 8, a drive wheel 112c is a sprocket having teeth 116c for driving the driven wheel 28c by a drive chain 148c.

As shown in FIG. 1a, the apparatus 10′ also includes a drive wheel 112′ having a further axis of rotation 114′ which is disposed spaced and approximately parallel to the axis of rotation 26′ of the auger 24′, the drive wheel 112′ driving the final driven wheel 28′. More particularly, the drive wheel 112′ is a drive gear pinion having a plurality of teeth 116, 117 and 118. The final driven wheel 28′ is a gear wheel having gear teeth 108-110 as shown in FIG. 7 which intermesh with the plurality of teeth 116-118 of the drive gear pinion 112′ so that when the drive gear pinion 112′ is rotated as indicated by the arrow 120, the final driven wheel 28′ and the auger 24′ are rotated. The floor 50 is disposed between the auger 24′ and the final driven wheel 28′, the floor 50 being secured to the second end 48 of the rim 44 such that the base 42, the rim 44 and the floor 50 define therebetween the encasement 52 for the final driven wheel 28′. Also, as shown in FIG. 2, the floor 50 and the base 42 further define a cavity 122 for the reception therein of the drive gear pinion 112′. The mixer apparatus 10′ further includes a drive gear pinion bearing 124 which is secured to the base 42 for rotatably supporting the drive gear pinion 112′ within the cavity 122. A drive shaft 126 is secured to the drive gear pinion 112′, the drive shaft 126 extending through the housing 16′ so that when the drive shaft 126 is rotated as indicated by the arrow 128, the drive gear pinion 112′, the final driven wheel 28′ and the auger 24′ are rotated.

FIG. 7 is an enlarged view of the drive gear pinion 112′ and driven wheel 28′. As shown in FIG. 7, the mixer apparatus 10′ further includes a guide 130 disposed in a vicinity of the plurality of teeth 116-118 of the drive gear pinion 112′ and the gear teeth 108-110 of the final driven wheel 28′. The arrangement is such that when the plurality of teeth 116-118 intermesh with the gear teeth 108-110 of the final driven wheel 28′, the intermeshing teeth 108-110 and 116-118 are guided by the guide 130 into an intermeshing relationship by the guide 130 as shown in FIG. 2. The guide 130 is secured to the drive gear pinion 112′ and is disposed between the drive gear pinion 112′ and the base 42 as shown in FIG. 2.

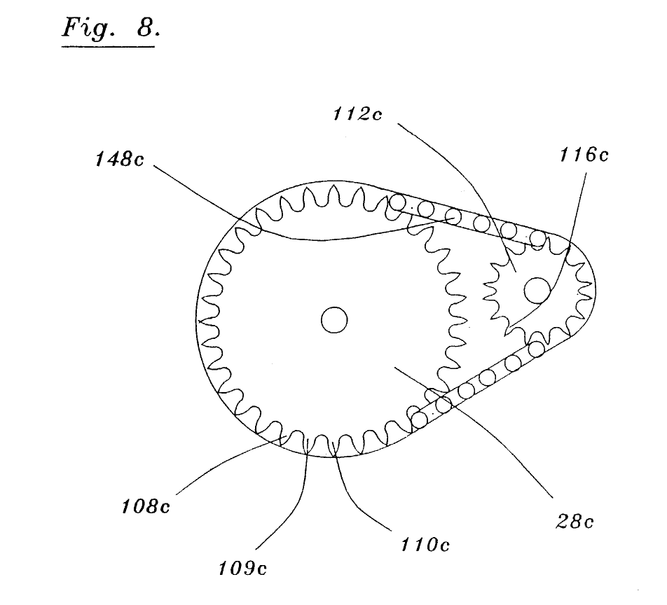

FIG. 9 is a top plan view of the mixer 10 shown in FIG. 1. As shown in FIG. 9, the further auger 136 is disposed within the enclosure 22, the further auger 136 having a rotational axis 138 disposed approximately parallel and spaced from the axis of rotation 26 of an auger 24.

As shown in FIG. 9, the drive wheel 112 is common to the auger 24 and the further auger 136. The drive wheel 112, part of which is shown in FIG. 9, includes the further axis of rotation 114 which is disposed spaced and approximately parallel relative to the axis of rotation 26 of the auger 24 and the rotational axis 138 of the further auger 136. The further axis of rotation 114 of the drive wheel 112 is disposed between the axis of rotation 26 of the auger 24 and the rotational axis 138 of the further auger 136.

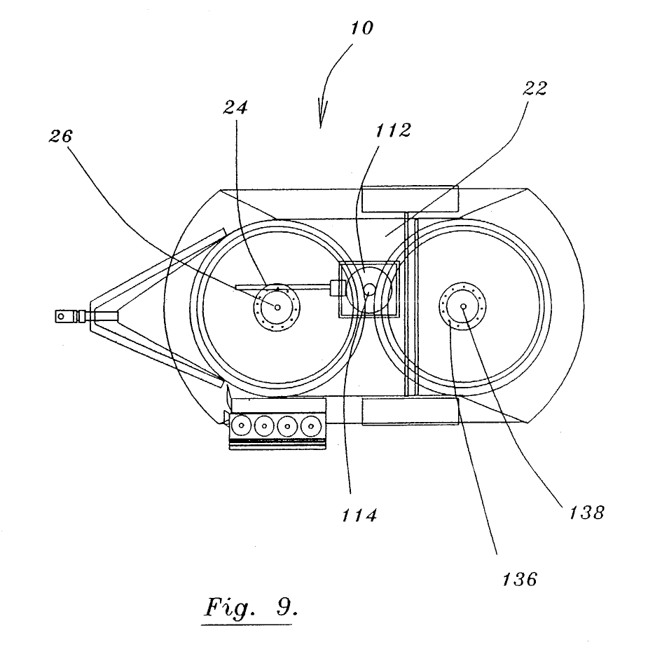

FIG. 10 is a diagrammatic representation viewed from the top of another embodiment of the present invention. As shown in FIG. 10, the axis of rotation 26e of the auger 24e and final driven wheel 28e is disposed between the further axis of rotation 114e of the drive wheel 112e and the rotational axis 138e of the further auger 136e. The drive wheel 112e is a drive gear pinion, the drive gear pinion having a plurality of teeth 116e-118e. The final driven wheel 28e is a gear wheel having gear teeth 108e-110e which intermesh with the plurality of teeth 116e-118e of the drive gear pinion 112e so that when the drive gear pinion 112e is rotated, the final driven wheel 28e and the auger 24e are rotated.

As shown in FIG. 10, the mixer apparatus 10e further includes a further final driven wheel 140, the further final driven wheel 140 being a further gear wheel having further gear teeth 142, 143 and 144 which are driven by the plurality of teeth 108e-110e of the driven wheel 28e. The arrangement is such that when the drive gear pinion 112e is rotated, the final driven wheel 28e and the auger 24e are rotated and the further final driven wheel 140 and further auger 136e are rotated. As shown in FIG. 10, a gear 141 is disposed between the wheels 28e and 140.

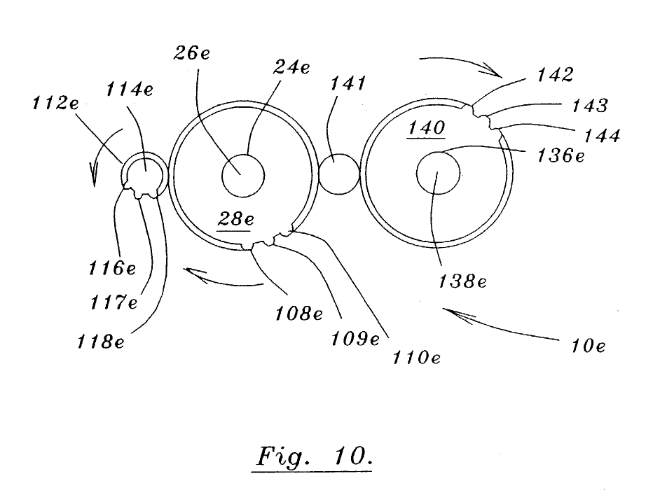

FIG. 11 is a top plan view of another embodiment of the present invention. As shown in FIG. 11, a drive wheel 112f is a first drive sprocket.

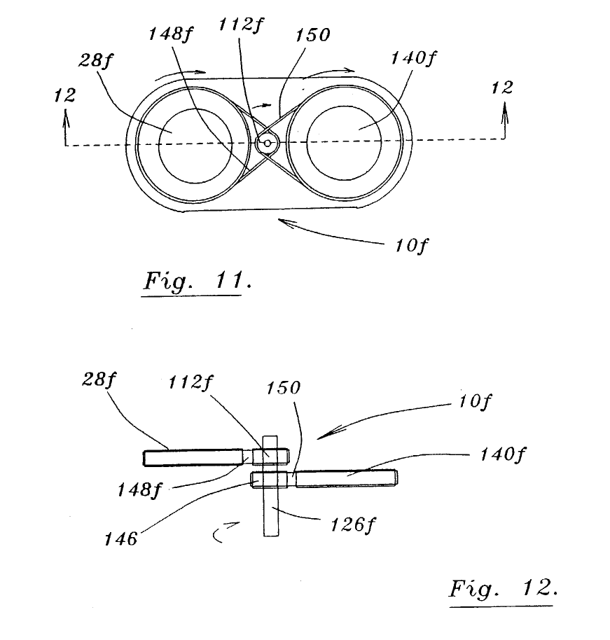

FIG. 12 is a sectional view taken on the line 12-12 of FIG. 11. As shown in FIG. 12, the mixer apparatus 10f further includes a second drive sprocket 146 which is secured to the first drive sprocket 112f and is disposed coaxially relative to the first drive sprocket 112f. A drive 148f extends around the first drive sprocket 112f and the final driven wheel 28f so that when the first drive sprocket 112f is rotated, the drive 148f rotates the final driven wheel 28f. Also, a further final driven wheel 140f is a further driven sprocket wheel. A further drive 150 extends around the second drive sprocket 146 and the further final driven wheel 140f so that when the second drive sprocket 146 is rotated, the further drive 150 rotates the further final driven wheel 140f. The drive 148f is a first roller chain drive and the further drive 150 is a second roller chain drive.

Those skilled in the art will appreciate that the arrangement shown in FIGS. 11 and 12 could include replacing the driven and drive sprockets with driven and drive pulleys with the drive roller chain being replaced with a belt drive. Similarly, the further driven and further drive sprockets and further roller chain drive could be replaced by a further driven pulley, further drive pulley and further drive belt respectively.

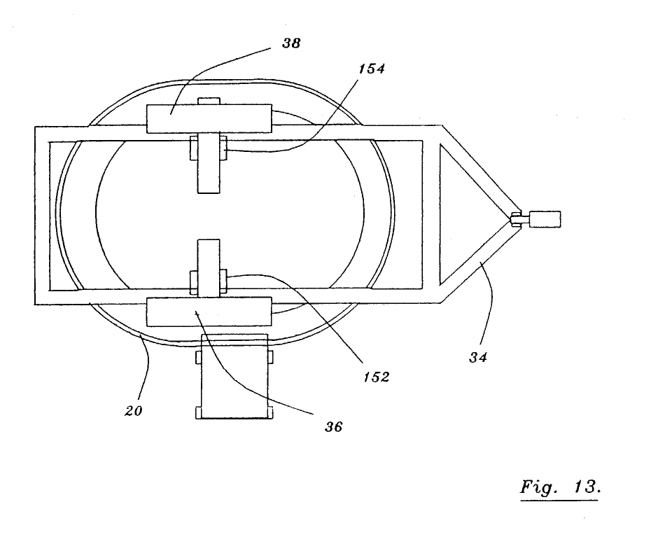

FIG. 13 is a view taken from beneath the mixer apparatus 10 shown in FIG. 3. As shown in FIG. 13, a plurality of wheels 36′ and 38′ shown in FIG. 1a includes the first wheel 36′ and the second wheel 38′ disposed spaced and coaxial relative to the first wheel 36′. A first load cell 152 is disposed between the first wheel 36′ and the frame 34′ and a second load cell 154 is disposed between the second wheel 38′ and the frame 34′ as shown in FIG. 13.

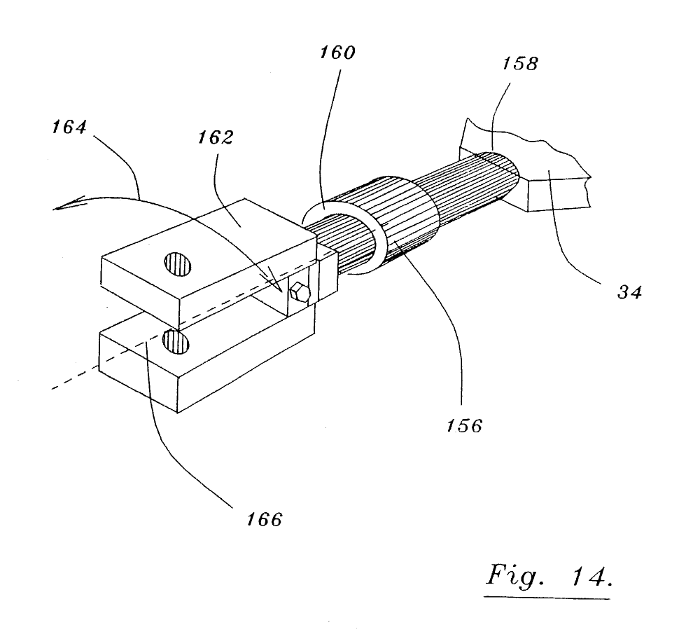

FIG. 14 is an enlarged perspective view of the hitch bar 40 as shown in FIG. 1. As shown in FIG. 14, the hitch bar 40 is connected to the frame 34 and is disposed remote from the wheels 36 and 38. A third load cell 156 has a first and a second end 158 and 160 respectively, the first end 158 of the third load cell 156 being secured to the frame 34. A clevis 162 is attached to the second end 160 of the third load cell 156, the clevis 162 being rotatable as indicated by the arrow 164, about a longitudinal axis 166 of the third load cell 156. The arrangement is such that during a weighing operation which is dependent on measurements from the first, second and third load cells 152, 154 and 156, the rotatable clevis 162 adjusts to a difference in an inclination of the mixer apparatus 10 and a tractor (not shown) so that side pressures and inaccuracies in measurements from the third load cell 156 is decreased.

Also, according to the present invention, as shown in FIG. 1a, the present invention relates to a mixer apparatus 10′ for mixing livestock feed 12′. The container 14′ has a housing 16′ and a wall 18′ extending away from the housing 16′, the wall 18′ defining an opening 20′ disposed remote from the housing 16′ for the reception therethrough of the feed 12′. The arrangement is such that the housing 16′ and the wall 18′ define therebetween an enclosure 22′ for the feed 12′ received through the opening 20′. An auger 24′ is disposed within the enclosure 22′, the auger 24′ having an axis of rotation 26′ extending through the housing 16′. Additionally, a substantially horizontally disposed drive pinion 112′ is provided which intermeshes with a final driven wheel 28′ which is driven by the drive pinion 112′ and disposed substantially horizontally within the housing 16′. The final driven wheel 28′ is rotatable about the axis of rotation 26′, the final driven wheel 28′ being drivingly connected to the auger 24′ so that when the final driven wheel 28′ is rotated within the housing 16′, the auger 24′ is rotated therewith within the enclosure 22′ for mixing the feed 12′. Also, the final driven wheel 28′ has a diameter D of at least three foot.

In a more specific embodiment of the present invention, the final driven wheel has a diameter D of at least four foot. More specifically, the final driven wheel has a diameter D of at least five foot.

FIG. 7a is a similar view to that shown in FIG. 7 but shows a preferred embodiment of the present invention. As shown in FIG. 7a, the final driven wheel 28′ is a bull gear having at least 50 gear teeth. More specifically, the final driven wheel 28′ has from 56 to 60 gear teeth and is flame hardened. As shown in FIG. 7a, the wheel 28′ has 58 gear teeth 108′, 109′ and 110′.

FIG. 7b is a view taken on the line 7b-b of FIG. 7a. As shown in FIG. 7b, the final driven wheel 28′ has a thickness T within a range from 1 to 4 inches and the pinion 112′ which intermeshes with the final driven wheel 28′ has between 10 and 12 gear teeth as shown in FIG. 7a.

The pinion 112′ has a thickness t within a range from 1.75 to 3 inches and has a thickness t which is greater than a thickness T of the final driven wheel 28′.

In a preferred embodiment of the present invention, the pinion 112′ which intermeshes with the final driven wheel 28′ is fabricated from steel and hardened.

In a final driven wheel having a diameter of 85 inches there will be 105 teeth whereas in a smaller driven wheel having a diameter of 60 inches, there will be 58 teeth.

In operation of the mixer apparatus 10 according to the present invention, the cover 56 is unbolted from the floor 50 and the auger 24 and final driven wheel 28 are removed upwardly as a single unit so that immediate inspection and servicing of the final driven wheel 28 and drive wheel 112 is permitted. Also, reassembly of the unit 32 which includes the auger 24 and final driven wheel 28 is a simple operation in which the unit is lowered through the enclosure 22 followed by refastening the cover 56 to the floor 50.

The present invention provides a vertical auger mixer having a number of unique features which reduce the cost of production thereof and provide a mixer which permits easy access for inspecting and servicing the drive gears thereof.

What is claimed is:

1. A mixer apparatus for mixing livestock feed and the like, said apparatus comprising:
a container for the reception therein of the feed;
said container including:
a housing;
a wall extending away from said housing, said wall defining an opening disposed remote from said housing for the reception therethrough of the feed, the arrangement being such that said housing and said wall define therebetween an enclosure for the feed received through said opening;
an auger disposed within said enclosure, said auger having an axis of rotation extending through said housing;
a final driven wheel disposed within said housing, said final driven wheel being rotatable about said axis of rotation, said final driven wheel being drivingly connected to said auger so that when said final driven wheel is rotated within said housing, said auger is rotated therewith within said enclosure for mixing the feed; and
said final driven wheel having a diameter of at least three foot.

2. A mixer apparatus for mixing livestock feed, said apparatus comprising:
a container for the reception therein of the feed;
said container including:
a housing;
a wall extending away from said housing, said wall defining an opening disposed remote from said housing for the reception therethrough of the feed, the arrangement being such that said housing and said wall define therebetween an enclosure for the feed received through said opening;
an auger disposed within said enclosure, said auger having an axis of rotation extending through said housing;
a substantially horizontally disposed drive pinion;
a final driven wheel driven by said drive pinion and disposed substantially horizontally within said housing, said pinion and final driven wheel intermeshing, said final driven wheel being rotatable about said axis of rotation, said final driven wheel being drivingly connected to said auger so that when said final driven wheel is rotated within said housing, said auger is rotated therewith within said enclosure for mixing the feed; and
said final driven wheel having a diameter of at least three foot.

3. A mixer apparatus as set forth in claim 2 wherein
said final driven wheel has a diameter of at least four foot.

4. A mixer apparatus as set forth in claim 2 wherein
said final driven wheel has a diameter of at least five foot.

5. A mixer apparatus as set forth in claim 2 wherein
said final driven wheel has a diameter of at least six foot.

6. A mixer apparatus as set forth in claim 2 wherein
said final driven wheel has a diameter of at least seven foot.

7. A mixer apparatus as set forth in claim 2 wherein
said final driven wheel is a bull gear.

8. A mixer apparatus as set forth in claim 2 wherein
said final driven wheel is a bull gear having at least 50 gear teeth.

9. A mixer apparatus as set forth in claim 2 wherein
said final driven wheel is a bull gear having from 56 to 105 gear teeth.

10. A mixer apparatus as set forth in claim 2 wherein
said final driven wheel is a bull gear which is flame hardened.

11 A mixer apparatus as set forth in claim 2 wherein
said final driven wheel has a thickness within a range from 1 to 4 inches.

12. A mixer apparatus as set forth in claim 2 wherein
said pinion which intermeshes with said final driven wheel has between 10 and 12 gear teeth.

13. A mixer apparatus as set forth in claim 2 wherein
said pinion which intermeshes with said final driven wheel has a thickness within a range from 1.50 to 4.50 inches.

14. A mixer apparatus as set forth in claim 2 wherein
said pinion which intermeshes with said final driven wheel has a thickness which is greater than a thickness of said final driven wheel.

15. A mixer apparatus as set forth in claim 2 wherein
said pinion which intermeshes with said final driven wheel is fabricated from steel and then hardened.

16. A mixer apparatus for mixing livestock feed, said apparatus comprising:
a container for the reception therein of the feed;
said container including:
a housing;
a wall extending away from said housing, said wall defining an opening disposed remote from said housing for the reception therethrough of the feed, the arrangement being such that said housing and said wall define therebetween an enclosure for the feed received through said opening;
an auger disposed within said enclosure, said auger having an axis of rotation extending through said housing;
a substantially horizontally disposed drive pinion;
a final driven wheel driven by said drive pinion and disposed substantially horizontally within said housing, said pinion and final driven wheel intermeshing, said final driven wheel being rotatable about said axis of rotation, said final driven wheel being drivingly connected to said auger so that when said final driven wheel is rotated within said housing, said auger is rotated therewith within said enclosure for mixing the feed; and
said final driven wheel having a diameter of at least four foot so that said intermeshing final driven wheel and said pinion permit mixing of compacted bales of the livestock feed.

17. A mixer apparatus for mixing livestock feed, said apparatus comprising:
a container for the reception therein of the feed;
said container including:
a housing;
a wall extending away from said housing, said wall defining an opening disposed remote from said housing for the reception therethrough of the feed, the arrangement being such that said housing and said wall define therebetween an enclosure for the feed received through said opening;
an auger disposed within said enclosure, said auger having an axis of rotation extending through said housing;
a substantially horizontally disposed drive pinion;
a final driven wheel driven by said drive pinion and disposed substantially horizontally within said housing, said pinion and final driven wheel intermeshing, said final driven wheel being rotatable about said axis of rotation, said final driven wheel being drivingly connected to said auger so that when said final driven wheel is rotated within said housing, said auger is rotated therewith within said enclosure for mixing the feed;
said final driven wheel having a diameter of at least four foot;
said final driven wheel being a flame hardened bull gear having between 56 and 105 gear teeth;
said final driven wheel having a thickness within a range from 1 to 4 inches;
said pinion which intermeshes with said final driven wheel having between 10 and 12 gear teeth;
said pinion which intermeshes with said final driven wheel having a thickness within a range from 1.50 to 4.50 inches;
said pinion having a thickness which is greater than a thickness of said final driven wheel; and
said pinion being fabricated from steel and then hardened.
